(19) United States
(12) Patent Application Publication
(10) Pub. No.: US 2012/0221238 A1
(43) Pub. Date: Aug. 30, 2012

(54) Clear sign rider

(76) Inventor: Gloria Shelby-Dyer, Los Angeles, CA (US)

(21) Appl. No.: 13/385,497

(22) Filed: Feb. 22, 2012

Related U.S. Application Data
(60) Provisional application No. 61/463,699, filed on Feb. 22, 2011.

(51) Int. Cl. G09F 7/18; G01C 21/00; B23P 11/00; G09F 13/00

(52) U.S. Cl. 701/400; 40/606.01; 40/541; 29/525.11

(57) ABSTRACT

A clear sign rider. The novel clear sign rider is designed for attaching a secondary sign to a frame for holding a primary sign, and includes a sheet of transparent plastic folded over to form two parallel layers adapted to receive and hold the secondary sign therebetween, and a feature formed in the plastic for attaching the plastic to the frame. In an illustrative embodiment, the clear sign rider is adapted to be inserted in and fastened to a sign rider slot attached to the frame. At least one layer of the clear sign rider includes a hole for engaging a screw that attaches the layer to the slot. In a preferred embodiment, the clear sign rider also includes a circuit for wirelessly transmitting data to nearby mobile devices.

### CROSS-REFERENCE TO RELATED APPLICATIONS

This application claims the benefit of U.S. Provisional Application No. 61,463,699, filed Feb. 22, 2011, the disclosure of which is hereby incorporated by reference.

### BACKGROUND OF THE INVENTION

1. Field of the Invention

The present invention relates to signs and displays. More specifically, the present invention relates to sign riders.

2. Description of the Related Art

Realtors often use directional signs placed on sidewalks or street corners to guide potential buyers to an open house. These signs typically include the words “Open House” and the name of the real estate company and/or agent, and maybe an arrow pointing in the direction of the property. Since the same sign can be used over and over again for different open houses, realtors usually have pre-made, custom printed signs for this purpose. Professionally fabricated signs are typically weatherproof and more sturdy and professional looking than a hand written sign.

In many cases, it would also be desirable to include the address of the open house property on these directional signs. The address of the open house, however, frequently changes. Having custom-made signs fabricated for every open house would be expensive, and could take several days to make. Currently, realtors typically resort to taping computer-printed paper signs displaying the property address onto the primary directional sign. Paper signs, however, can be easily torn or ruined by rain, snow, or wind. Alternatively, realtors could hand-write the property address on chalkboard, dry erase board, or similar material for nonpermanent markings, but chalk and ink can also be easily erased or blurred by rain or snow. Further, a hand-written sign might be perceived as looking unprofessional.

Hence, a need exists in the art for an improved system or method for displaying a property address on an open house sign that is more robust to weather than paper or nonpermanent signs, but less expensive and easier and faster to make than professionally fabricated signs.

### SUMMARY OF THE INVENTION

The need in the art is addressed by the clear sign rider of the present invention. The novel clear sign rider is designed for attaching a secondary sign to a frame for holding a primary sign, and includes a sheet of transparent plastic folded over to form two parallel layers adapted to receive and hold the secondary sign therebetween, and a feature formed in the plastic for attaching the plastic to the frame. In an illustrative embodiment, the clear sign rider is adapted to be inserted in and fastened to a sign rider slot attached to the frame. At least one layer of the clear sign rider includes a hole for engaging a screw that attaches the layer to the sign rider slot. The sign rider slot may be a built-in component of the frame, or part of a mounting attachment that includes the sign rider slot for receiving the clear sign rider plus a clamp for attaching the mounting attachment to the frame. In a preferred embodiment, the clear sign rider also includes a circuit for wirelessly transmitting data to nearby mobile devices.

### BRIEF DESCRIPTION OF THE DRAWINGS

FIG. 1 is a simplified diagram of a display system in accordance with an illustrative embodiment of the present invention.

FIG. 2 is a simplified diagram of a clear sign rider in accordance with an illustrative embodiment of the present invention

FIG. 3a is a simplified diagram of a side view of a clear sign rider in accordance with an illustrative embodiment of the present invention.

FIG. 3b is a simplified diagram of a side view of a clear sign rider in accordance with an alternate illustrative embodiment of the present invention.

FIG. 4a is a simplified diagram of a side view of a mounting attachment in accordance with an illustrative embodiment of the present invention.

FIG. 4b is a simplified diagram of a front view of a clear sign rider in a mounting attachment in accordance with an illustrative embodiment of the present invention.

FIG. 5 is a simplified block diagram of a clear sign rider communication system in accordance with an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

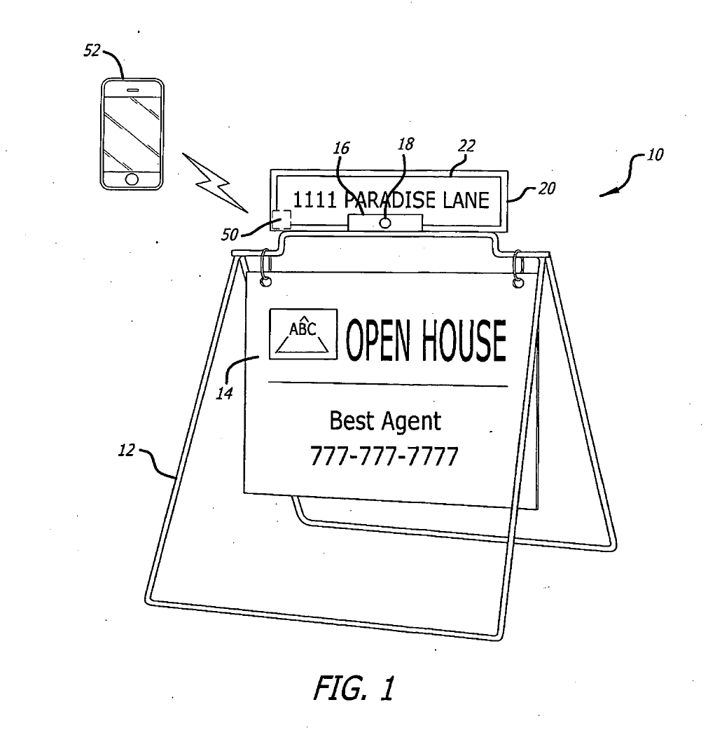

The present invention provides a novel clear sign rider for attaching a secondary sign that displays a property address to a sign frame that holds a primary sign. FIG. 1 is a simplified diagram of a display system 10 in accordance with an illustrative embodiment of the present invention. The illustrative display 10 includes a conventional round rod A-frame 12 commonly used by realtors. The frame 12 is adapted to hold a primary sign 14, which is typically a professionally fabricated sign that includes general information such as the words “Open House”, the name of the real estate company and/or agent, and contact information.

Many commercially available frames of this type also include a built-in slot 16 for holding a secondary sign or sign rider. A sign rider is a smaller sign that usually includes property specific information such as “4 Bedrooms” or “Pool”. In accordance with conventional practices, sign riders are typically also professionally fabricated signs, and pre-made signs with commonly used words and phrases are widely available for purchase.

As discussed above, many realtors would also like to include the address of the open house property somewhere on the display 10. The present invention provides a novel clear sign rider 20 for this purpose. The clear sign rider 20 is adapted to hold and protect a paper sign 22 and is designed to be attached to the sign rider slot 16 of a conventional frame 12. The size of the clear sign rider 20 should be smaller than the primary sign 14. For example, the clear sign rider 20 might be sized 6″×18″ for a primary sign 14 sized 18″×24″.

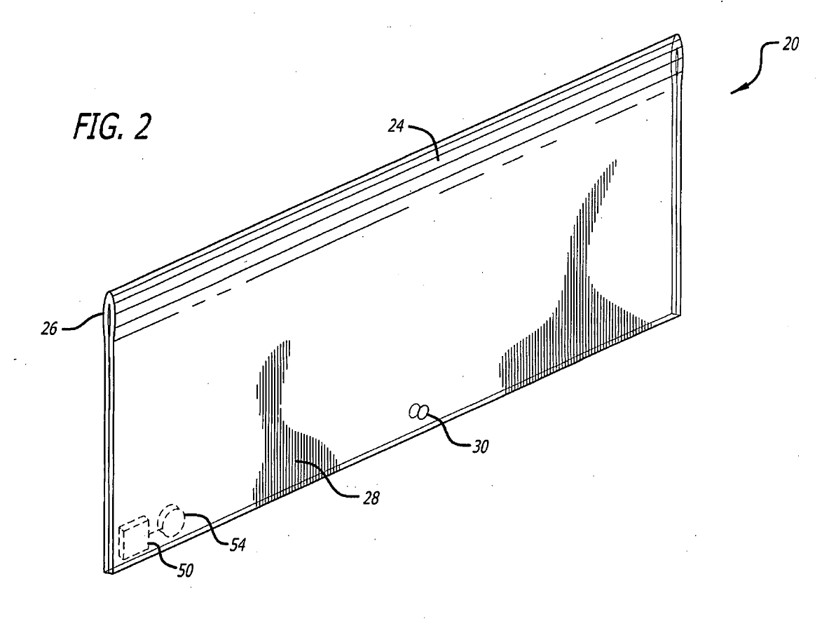

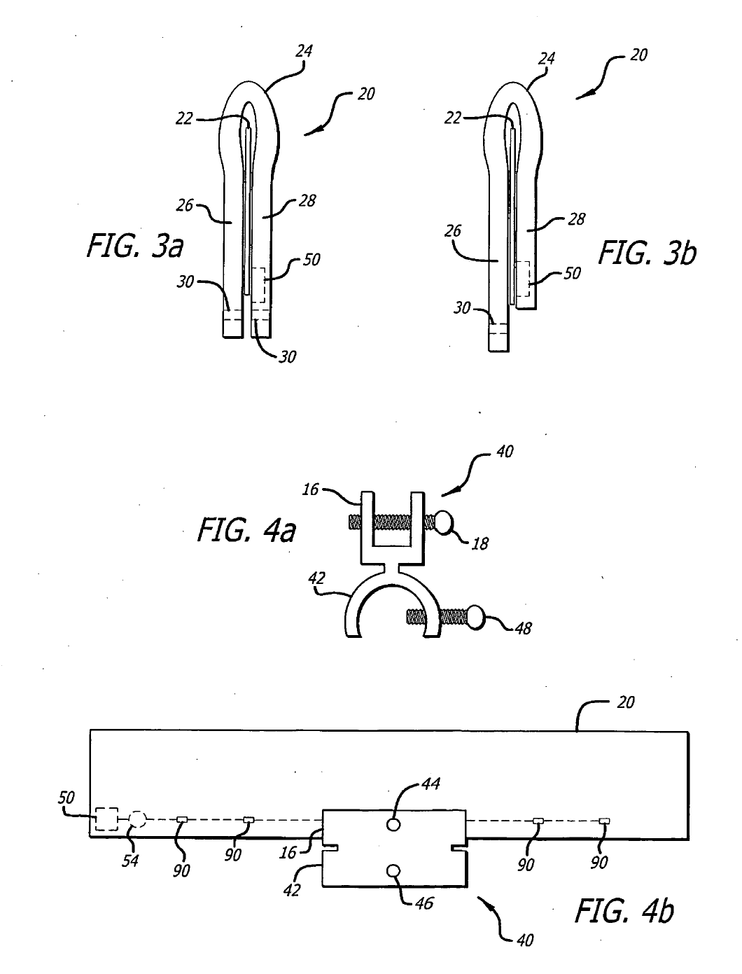

FIG. 2 is a simplified diagram of a clear sign rider 20 in accordance with an illustrative embodiment of the present invention, and FIG. 3a shows a side view of the clear sign rider 20 of FIG. 2. In accordance with the present teachings, the clear sign rider 20 includes a sheet of transparent plastic 24 folded over to form two parallel layers 26 and 28 such that a sheet of paper 22 can be received and held between the two layers 26 and 28. The thickness of the plastic sheet 24 should be thick enough to avoid cracking or breaking when inserting the paper sign 22 and also to provide a rigid protective housing for the paper sign 22, but thin enough such that the clear sign rider 20 will fit in the built-in sign rider slot 16 of most conventional sign frames 12. In the preferred embodiment, the clear sign rider 20 is made from 3 mm thick plexiglass (also known as acrylic glass or PMMA).

The clear sign rider 20 also includes a feature 30 formed in the plastic 24 for attaching the clear sign rider 20 to a sign frame 12. As shown in FIG. 1, the bottom (open) edge of the clear sign rider 20 is designed to fit in the built-in sign rider slot 16 of conventional sign frames 12. In the illustrative embodiment of FIGS. 2 and 3a, both layers 26 and 28 of the clear sign rider 20 are of the same length, and both layers 26 and 28 are designed to fit in the sign rider slot 16. In this embodiment, a hole 30 is drilled through each layer 26 and 28 near the center of the bottom edge for engaging a screw 18 that attaches the clear sign rider 20 to the sign rider slot 16.

FIG. 3b shows a side view of an alternate embodiment in which one layer 26 is slightly longer than the second layer 28. In this embodiment, the clear sign rider 20 is formed from a sheet of plexiglass 24 that is too thick to allow two layers to fit in the sign rider slot 16. In this case, one layer 28 is made shorter (by the height of the sign rider slot 16, typically about 1 cm) such that only the longer layer 26 is inserted into the sign rider slot 16, and only the longer layer 26 includes a hole 30 for engaging the screw 18.

In the preferred embodiment, the clear sign rider 20 is designed so that it can be easily attached to current, conventional frames 12 with a built-in sign rider slot 16. The clear sign rider 20 can also be attached to other types of frames, including frames without a built-in sign rider slot 16, using a separate mounting attachment 40. The frame 12 shown in FIG. 1, for example, is an A-frame constructed of ⅜″ round metal rod for holding a single double-sided primary sign, which often includes a built-in sign rider slot 16. Another sign frame commonly used by realtors is an A-frame made of PVC plastic tubing for holding two single-sided primary signs, which typically does not include a built-in sign rider slot. For these frames and other types of frames that do not include a sign rider slot, a mounting attachment 40 can be used to attach the clear sign rider 20 to the frame.

FIG. 4a shows a side view of a mounting attachment 40 in accordance with an illustrative embodiment of the present invention, and FIG. 4b shows a front view of the mounting attachment 40 with the clear sign rider 20 attached. The mounting attachment 40 includes a slot 16 for receiving the clear sign rider 20 and a clamp 42 for securing the mounting attachment 40 to part of a frame 12. The slot 16 includes holes 44 in both sides of the slot 16 for allowing a screw 18 to pass through the slot 16 and the hole or holes 30 of the clear sign rider 20, securing the clear sign rider 20 to the mounting attachment 40. The clamp 42 includes a hole 46 on one side for allowing a screw 48 to be tightened against the frame 12.

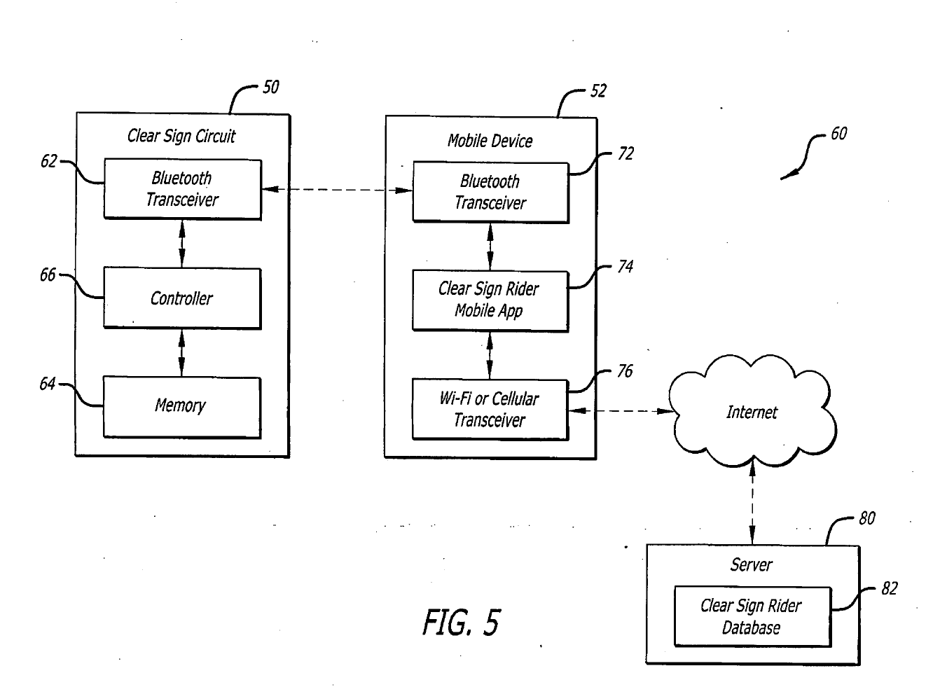

In a preferred embodiment, the clear sign rider 20 also includes a circuit 50 powered by a battery 54 that is embedded in or otherwise attached to the plastic 24 for wirelessly communicating data to a mobile device 52 such as an iPhone or other smart phone or tablet (as shown in FIG. 1). FIG. 5 is a simplified block diagram of a clear sign rider communication system 60 in accordance with an illustrative embodiment of the present invention. The communication system 60 includes a circuit 50 in the clear sign rider 20 that includes a transceiver 62 for transmitting and receiving Bluetooth signals (other wireless communications protocols other than Bluetooth could also be used without departing from the scope of the present teachings; however, Bluetooth would be preferred because it provides for a low cost, low power implementation that is compatible with most current mobile devices), a memory device 64 for storing data to be transmitted, and a controller circuit 66 for controlling data transmission.

In an illustrative embodiment, the data stored in memory 64 includes the property address and may also include additional information about the property that might be of interest to potential buyers such as the number of bedrooms/baths, square footage, central air, pool, etc. The data may be input to the circuit 50 wirelessly (via a Bluetooth signal), or alternatively, the circuit 50 may include a data interface such as a micro-USB port. This data can then be transmitted to nearby visitors, who may be on foot or in a car, via their cellular phones or other mobile devices 52.

In operation, when the circuit 50 is turned on, the Bluetooth transceiver 62 broadcasts an identification signal requesting to send a file via a Bluetooth connection. When a mobile device 52 with an enabled Bluetooth transceiver 72 comes within range of the identification signal, it receives the Bluetooth request and asks the user of the mobile device 52 to accept or deny the request. If the user accepts the request, the clear sign circuit controller 66 sends the data stored in memory 64 to the mobile device 52 in a compatible format such as a text file, picture, or multimedia file. The mobile device 52 receives and displays the data to the user.

Alternatively, the mobile device 52 may include a mobile application 74 designed specifically for receiving data from clear sign riders 22. In this case, when the mobile device 52 receives a Bluetooth request from a clear sign circuit 50, the mobile device 52 automatically opens the clear sign rider mobile application 74, which is programmed to display the data received, and preferably also to provide directions to the property using the default GPS navigation system of the mobile device 52.

In an alternate embodiment, instead of manually entering property addresses and data into each clear sign rider 20, each rider circuit 50 may be configured with a unique identification code. This code is the only data transmitted by the circuit 50. The realtor can then input the property address and data for each clear sign rider 20 into an online database 82 stored on a server 80. When a mobile device 52 receives an identification code from a clear sign circuit 50, the clear sign rider mobile application 74 accesses the database 82 using the default internet connection of the mobile device 52 (e.g., Wi-Fi or a cellular transmission 76) and retrieves the data corresponding to the received identification code. The mobile application 74 can then display the data and/or navigate to the property as described above.

In a preferred embodiment, the circuit 50 and battery 54 are embedded within the plastic 24 to protect them from the weather. Since only a portion of the clear sign rider 20 is inserted in the mounting slot 16 (see FIG. 4b), the circuit 50 and battery 54 can be placed away from the mounting slot 16, such as near a corner as shown in FIG. 4b, where the plastic 24 can be made slightly thicker to accommodate the circuit 50 and battery 54. The battery 54 may be a rechargeable battery adapted to be charged via inductive charging, or the battery 54 may be encased in a removable cover allowing it to be replaced.

Optionally, the clear sign rider 20 may also include a mechanism for illuminating the sign 22. In an illustrative embodiment, a plurality of light emitting diodes (LEDs) are embedded within the plastic 24 and powered by the battery 54 to provide lighting for the sign 22.

Thus, the novel clear sign rider 20 of the present invention provides an efficient, clean, clear display for property addresses that can be easily attached to conventional real estate sign frames. The desired address can be printed quickly and easily by a computer, and the resulting paper printout 22 is slid between the two transparent layers 26 and 28 of the clear sign rider 20. The paper sign 22 is thus protected from weather by the plexiglass 24. The clear sign rider 20 is then inserted in the built-in sign rider slot 16 of the sign frame 12 and secured by a screw 18, or similarly screwed into a mounting attachment 40, which is then attached to the sign frame 12. The property address and additional data can also be electronically input to a circuit 50 in the clear sign rider 20, or into an online database 82. The circuit 50 transmits the data to nearby mobile devices 52, which then display the received data and guides the user to the property. The paper sign 22 and electronic data can be easily and quickly changed at minimal expense, allowing the realtor to reuse the clear sign rider 22 over and over for different open houses.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claim is:

1. A clear sign rider for attaching a secondary sign to a frame for holding a primary sign, said clear sign rider comprising:
a sheet of transparent plastic folded over to form two parallel layers adapted to receive and hold said secondary sign therebetween, and
first means for attaching said plastic to said frame.

2. The invention of claim 1 wherein said clear sign rider is adapted to be inserted in a sign rider slot attached to said frame.

3. The invention of claim 2 wherein said first means includes a feature formed in said plastic for attaching at least one said layer to said sign rider slot.

4. The invention of claim 3 wherein said two layers have a similar length and each layer includes a hole adapted to engage a screw for attaching said layers to said sign rider slot.

5. The invention of claim 3 wherein one said layer is longer than the other and said longer layer includes a hole adapted to engage a screw for attaching said longer layer to said sign rider slot.

6. The invention of claim 3 wherein said sign rider slot is a built-in feature of said frame.

7. The invention of claim 3 wherein said first means further includes a mounting attachment for attaching said plastic to said frame.

8. The invention of claim 7 wherein said mounting attachment includes a sign rider slot for receiving said at least one layer and a clamp for attaching said mounting attachment to said frame.

9. The invention of claim 1 wherein said clear sign rider is made from 3 mm thick plexiglass.

10. The invention of claim 1 wherein said clear sign rider is adapted to receive a secondary sign made from paper.

11. The invention of claim 1 wherein said clear sign rider further includes second means for wirelessly transmitting data to a mobile device.

12. The invention of claim 11 wherein said second means includes a Bluetooth transceiver attached to said plastic.

13. The invention of claim 1 wherein said clear sign rider further includes third means for illuminating said secondary sign.

14. The invention of claim 13 wherein said third means includes at least one light emitting diode embedded in said plastic.

15. A display system comprising:
a frame for displaying a first sign;
a clear sign rider for holding and displaying a second sign, wherein said clear sign rider includes a sheet of transparent plastic folded over to form two parallel layers adapted to receive and hold said second sign therebetween and a hole formed in at least one said layer for attaching said plastic to said frame; and
a mechanism for attaching said clear sign rider to said frame via said hole.

16. The invention of claim 15 wherein said system further includes a circuit in said clear sign rider for wirelessly transmitting data to a mobile device.

17. The invention of claim 16 wherein said system further includes a mobile application installed in said mobile device adapted to receive and display said data.

18. The invention of claim 17 wherein said mobile application is adapted to provide directions to an address supplied by said data.

19. A method for attaching a secondary sign to a frame for holding a primary sign, said method including the steps of
providing a sheet of transparent plastic folded over to form two parallel layers adapted to receive and hold said secondary sign therebetween and having a hole formed in at least one said layer for attaching said plastic to said frame;
inserting said secondary sign between said two layers of plastic;
inserting at least one said layer into a sign rider slot attached to said frame; and
fastening said layer to said sign rider slot with a screw.
